(19) United States
(12) Patent Application Publication
(10) Pub. No.: US 2001/0027828 A1
(43) Pub. Date: Oct. 11, 2001

(54) Mobile wood joinery

(76) Inventor: Malcolm Gibson Hodgskiss, Hamilton (CA)

Correspondence Address: Malcolm G. Hodgskiss, 112 St. Josephs Dr, # 307, Hamilton, ON, L8N 2E7, CA

(21) Appl. No.: 09/846,228

(22) Filed: May 2, 2001

(30) Foreign Application Priority Data
Apr. 5, 2000 (CA) 2,307,362

(51) Int. Cl. B27F 1/00; B27F 5/00

(52) U.S. Cl. 144/345

(57) ABSTRACT

The durable products of prior art woodworking have always been unyielding constructions of individual wooden elements held rigidly in place by rigid means such as joinery, fasteners, adhesives, or supporting structures. In the present invention a new method of mobile wood joinery alone is used to draw the wooden elements into place while yet allowing them a range of motion. The joinery of the present invention is mobile, resilient, elastic, and dimensionally dynamic and so are the products made using the present invention. In the present invention a width of resilient elastic adhesive is bonded to the adjoining surfaces of the unmilled individual wooden elements of a wooden product. When the adhesive dries, a mobile, resilient, elastic, dimensionally dynamic joint has been formed. This joint can be bent, hinged, stretched, or compressed in many different directions. The individual wooden elements joined using the present invention can move independently of each other. The joint formed by the present invention is inexpensive and easy to form, yet will not be destroyed or loosened by impact during use or by dimensional swelling and contracting of the individual wooden elements it draws together. The individual wooden elements will not be permanently displaced or damaged by impact or by swelling and contracting of the wood, but will always be drawn back to their original correct positions by the mobile joinery of the present invention.

### BACKGROUND OF THE INVENTION

The durable products made of wood have all been assemblies of wooden pieces held rigidly in place by various means. However, this rigidity of construction has pitted joinery, fasteners, adhesives and supporting structures against powerful expansion forces inherent in wood. Many problems result from this basic conflict between prior art joinery techniques and the dimensionally dynamic character inherent in wood. Wooden products are ton, crushed, splitted, cracked, weakened and destroyed. Further, a great deal of wood use and expense occurs in the use of prior art joinery. The present invention eliminates these shortcomings of prior art joinery by using a new joinery technique that is more dimensionally dynamic than the wood it joins.

### BRIEF SUMMARY OF THE INVENTION

The present invention of Mobile Wood Joinery joins individual pieces of a wooden product together while still allowing them a range of motion. Mobile wood joinery accommodates the natural expansion and contraction of wood and thus prevents damage to the wooden structure. Flexible joinery of the present invention provides further unique advantages. A ‘wooden rug’ may be made that is flexible and so adapts to contours in underlying substrates. If the ‘wooden rug’ is made to fill an entire room it constitutes a prefinished, pre-laid, hardwood floor that has no V groove or bevel, has no cracks or fasteners and thus does not squeak under foot. This remedies several long-standing problems inherent in prior art wood flooring products while reducing lumber use by 70%. A prefinished pre laid floor may be made using the joinery of the present invention that is only ⅛ of an inch thick. Prior art tongue and groove flooring cannot be made this thin because the tongue and grooves would only be 1/24 inch thick. This is too thin for milling, and for use.

### BRIEF DESCRIPTION OF THE DRAWINGS

In the drawing which illustrate embodiments of the invention, FIG. 1 is a top view of one embodiment of the invention. FIG. 2 is a frontal view of FIG. 1. FIG. 3 is an enlargement of area A of FIG. 2. FIG. 4 is a top view of a second embodiment of the invention. FIG. 5 is a frontal view of FIG. 4.

FIGS. 1, 2, and 3 illustrate a preferred embodiment of the present invention consisting of a patterned wooden “rug”. This wooden rug is made of a number unmilled wooden pieces 1, placed in a pattern. A resilient elastic dimensionally dynamic joinery adhesive 2 is then applied to fill the spaces between the unmilled pieces of wood. When the adhesive dries the traffic surface is sanded and finished with varnish or the like. A smooth, even level portable wooden floor surface is produced.

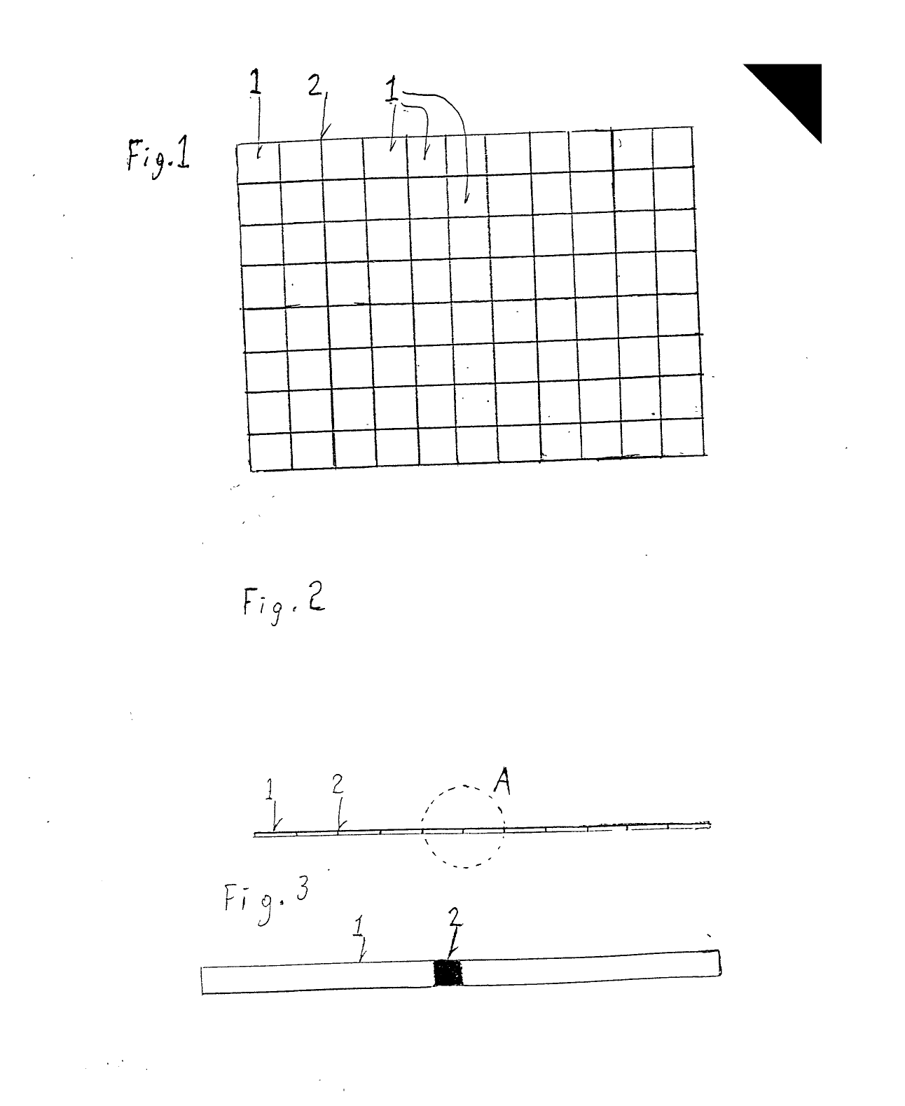

FIGS. 4, and 5 illustrate a second embodiment of the present invention consisting of unmilled strips of wood 3 of equal width and thickness but of random lengths laid closely side by side. The space between the strips is then filled with resilient elastic dimensionally dynamic joinery adhesive 2. The resulting panels are sanded and finished with varnish or the like. A prefinished wooden floor panel is produced that is smooth, even and level and has no overwood catch, no V groove, no bevel or micro bevel. The panel is resilient and flexible not rigid, so it can accommodate contours and irregularities in substrates upon which it rests. This prefinished wooden floor panel may be fastened to one or more similar panels by means of a hook loop fastener or an adhesive tape 4 applied to the bottom of the seam. Then joinery adhesive 2 may be applied to the seam and tooled smooth. In this way a prefinished floor can be installed in any size of room. Alternatively a single large panel may be made that can be rolled up for transport. This eliminates the need to join panels.

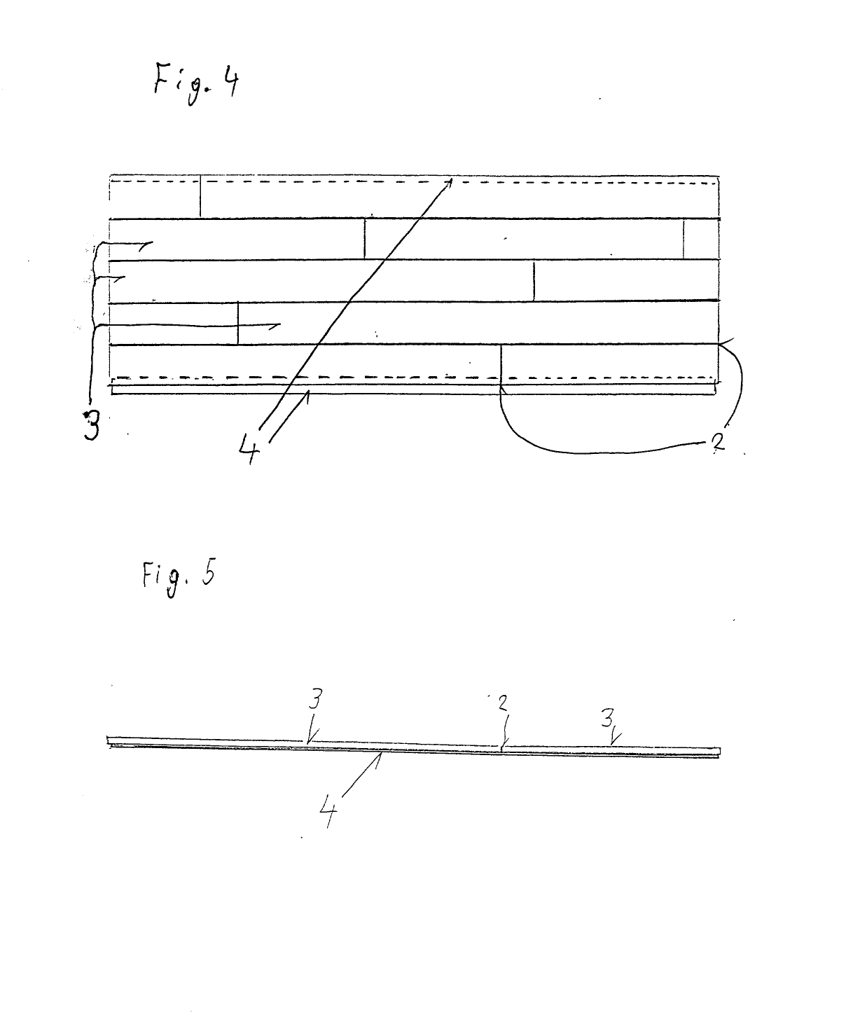

### DETAILED DESCRIPTION

This invention relates to the methods by which the individual wooden elements of various wooden products are held together to form these products. Durable wooden products have been made using two or more of the following four methods.

The first method of prior art is wood joinery such as mortise and tenon or tongue and groove and the like. Here, appendages are precisely milled into the surfaces of wooden pieces that are to be held together. Milling the joinery produces a great loss of useable wood. In the case of flooring, a plank of wood 50mm (two inches) wide by 19mm (0.75 inches) thick in its unmilled form will have a usable width of only 44mm (1.75 inches) and a usable thickness of less than 6mm (0.25 inches) after tongue and groove joinery have been added. This loss occurs when a 19mm (0.75 inches) thick tongue and groove plank wears down 6mm (0.25 inches). The groove splits off and the tongue is exposed. This renders the remaining 13mm (half inch) thickness unserviceable. This means that about seventy five percent of the useable wood volume is lost because of tongue and groove joinery. However the present invention does not require expensive milling or precise fitting. In the present invention the individual wooden elements need only be loosely shaped. As a result one hundred percent of the wood volume is used without any loss due to the millwork.

Another shortcoming of prior art joinery occurs in the case of prefinished wooden floors. The joinery of prefinished flooring is always milled to fit. However when the wood is installed at a later time dimensional fluctuations (due to temperature and moisture variations) of the wood itself have slightly displaced the original joinery. As a result, prefinished wooden floors are made with a V groove, a bevel, or a micro bevel to accommodate this joint displacement. This beveled edge results in a floor that is not smooth and even and catches grit. However the joinery of the present invention is resilient and elastic and moves with dimensional fluctuations of the wood without displacing the joints. As a result prefinished wooden floors that are smooth even and level and have no bevel can be made with the present invention.

A second method of prior art is the use of fasteners such as nails, screws, clamps, hinges, dowels, and others. These fasteners are an additional cost and take effort to use. They can cause damage to wood such as splitting even if pilot holes are drilled (another expense). When the wood moves against the fasteners it makes unpleasant squeaking and the fasteners can rust, thus further damaging the wood. Fasteners often need to be counter sunk below the surface and concealed with wood filler or they detract from the appearance of the product. The present invention avoids the cost and damage associated with the use of fasteners of any kind.

The third method used in prior art to hold together the individual wooden elements of wooden products is that of a supporting structure of wood, masonry, plastic, or other material. In the case of flooring the supporting structure may be a subfloor of plywood or of concrete. The flooring planks are then nailed or glued to the subfloor and held rigidly in place. The ribs of a boat may be a supporting structure that holds together the pieces of the hull. Supporting structures have no immediate use in themselves but are a cost necessary to hold the useful wooden elements together in place just as nails or joinery are an expense.

An example of this is the wooden decking of some boats. The decking is held together by framing within the hull or by a surface of the hull to which the decking is attached. The present invention improves over prior art where supporting structure's hold the individual elements in place because the present invention requires no supporting structure.

The forth method used in prior art to hold the individual elements of wooden products together is adhesives. Adhesive application may be used to supplement joinery or fastenings that would otherwise be loose and weak or it may be used to hold pieces of wood to a supporting structure.

Adhesives may be applied to pieces of wood, which are then clamped tightly together to produce laminated wood products. However prior art adhesive applications and prior art methods generally hold the individual wooden elements of wooden products rigidly in place to produce products of an unyielding construction character. This rigidity of construction pits the strength of joinery, fasteners, supporting structures, and adhesives against the natural expansion forces of the wood. The wood expands and contracts due to humidity, temperature, species of wood and even character of wood such as heartwood, sapwood, or knots. Over time this dimensional instability of wood will loosen and tear fasteners, joinery and adhesives free, destroying the wooden product or requiring costly repairs. In the case of wooden floors dimensional instability of wood can lead to squeaking, buckling, or compression set crack between boards as the wood fibre itself is crushed permanently by expansion, and then opens up as the board contracts.

The present invention avoids the expense and shortcoming of prior art discussed above by moving, compressing or stretching to accommodate dimensional fluctuations of the wood itself or impact from use.

In the development of the present invention a number of different resilient elastic adhesives were tested. The thickness of the adhesive joints ranged from 1.5mm (0.06 inches) to 19 mm (0.75 inches) and the depth also ranged from 1.5mm (0.06 inches) to 19mm (0.75 inches). The thickness of wood joined similarly ranged from 1.5mm (0.06 inches) to 19mm (0.75 inches). A variety of different woods were tested including red oak, ash, maple, walnut, spruce, and pine. The criteria were strength of bond to the wooden element, tensile strength of the adhesive joint itself, and resiliency, elasticity and mobility of the adhesive joint itself. The results ranged from good to excellent depending on the kind of resilient elastic adhesive used rather than depending on the species of wood or the width and depth of the adhesive joint. Elastic joinery that is thinner or thicker than the range described above is certainly possible.

Resilient elastic adhesive that performed well in the above trials included a moisture cured urethane rubber adhesive with an elongation at break of more than 250 percent, a tensile strength of 190 psi, excellent adhesion, shore A hardness (DIN 53505) of 35-40, and a tear propagation strength of 1450 psi. Another successful adhesive was a polyether ether adhesive which had similar properties to the moisture cured urethane described above except that it had a 500 percent elongation at break. Certainly many different adhesives would have adequate resilience, elasticity, adhesion, and strength to serve in the present invention.

What is claimed is

1. A resilient, elastic, dimensionally dynamic mobile method of adhesive wood joinery complete in itself without fasteners, joinery millwork or supporting structures.

2. The joinery of claim 1 wherein the joints exhibit hinge like flexibility in many different directions.

3. The joinery of claim 1 wherein the individual wooden elements move freely and independently of each other.

4. The joinery of claim 1 wherein the adjoining edges of the individual wooden elements contact each other.

5. The joinery of claim 1 wherein the wooden elements joined are not displaced permanently by impact or expansion but are drawn back to their original position.

6. The joinery of claim 1 wherein the wooden elements joined need not be precisely milled or fitted for a perfectly tight joint to be formed.
